(19) United States
(12) Patent Application Publication
(10) Pub. No.: US 2006/0105288 A1
(43) Pub. Date: May 18, 2006

(54) DENTAL MIRROR FOR ALIGNING DENTAL IMPLANTS

(76) Inventor: Leonard M. Garfinkel, Aventura, FL (US)

Correspondence Address: MALIN HALEY AND DIMAGGIO, PA, 1936 S ANDREWS AVENUE, FORT LAUDERDALE, FL, 33316, US

(21) Appl. No.: 10/904,561

(22) Filed: Nov. 16, 2004

(51) Int. Cl. A61C 3/00; A61C 3/02

(52) U.S. Cl. 433/31; 433/76

(57) ABSTRACT

An improved mirror for a periodontist that includes indicia alignment and spacing on the mirror at a predetermined location that provides for manual alignment of a drill that can be used by the periodontist for drilling an accurately aligned hole for a dental implant while holding the mirror in one hand observing the indicia and holding the drill in the other hand. The mirror can also be used by a dentist, periodontist and orthodontist to allow better patient access to facilitate looking at various teeth and gum areas in a patient's mouth by providing mirror peripheral shapes that fit lip, tongue and areas between the cheek and gums.

### FIELD OF THE INVENTION

This invention relates generally to a mirror that allows for observation of alignment for drilling an implant into the jaw by a periodontist and, specifically, for a mirror with an inscribed representation of a tooth to properly align the implant drilling into the jaw bone.

### DESCRIPTION OF RELATED ART

The use of observation mirrors for examining the condition of a patient's tooth or teeth is well known. The small circular mirror mounted on an elongated shaft that is angled at one end is known as the “lollipop mirror” and has been used for a long time to provide a dentist with the ability to look at each tooth in the patient's mouth through manual manipulation of the mirror handle. The primary drawback of this mirror is that the dentist can only look at one tooth at a time.

Mirrors are used not only by dentists for looking at cavities or the condition of a tooth but also by periodontists for performing tooth implants. Mirrors can be useful for a specialized dentist performing his or her craft. For example, when a periodontist performs an implant, the drilling of a hole in the jaw bone required for mounting the implant shaft into the jaw must be performed at a critical location and angle along the jaw bone. Orthodontists also must provide alignment of braces and other elements. Other uses of a mirror by dentists would be for observing bridgework required for a patient.

U.S. Pat. No. 6,666,682, issued Dec. 23, 2003, shows an intra-oral mirror that is substantially rectangular that includes a series of calibrations around the edge of the mirror. U.S. Pat. No. 5,076,784, issued Dec. 31, 1991, shows an orthodontic mirror that is rectangular and elongated to show more than a single tooth. U.S. Pat. No. 3,599,334, issued Aug. 17, 1971, shows a curved intra-oral visual paralleler that includes an optical lens for viewing certain portions of the teeth. The purpose is to provide optimum positioning for dental bridgework. U.S. Design Pat. No. D215,721, issued Oct. 28, 1969, shows a dental mirror that has a pair of curved surfaces. No description is provided as to the use of the mirror. U.S. Design Pat. No. D463,554, issued Sep. 24, 2002, shows a mouth mirror. This device is elongated and apparently has two different sized mirrors, one at each end. U.S. Pat. No. 4,412,821, issued Nov. 1, 1983, shows a dental mouth mirror having a plurality of curved surfaces. The arcuate indentations are formed in the posterior edge of the plate and posterior lobe portions at opposite ends. The purpose of the device is for the installation of orthodontic brackets that allows a full mouth view of one half of the mouth, either upper or lower. U.S. Pat. No. 6,347,940, issued Feb. 19, 2002, shows an instrument that allows a periodontist to verify the minimum distance between two teeth for the placement of one or two bone-integrated screwed implants. This device is not a mirror but is a guide for spacing holes for drilling.

None of the references shown in the prior art provide an easily manipulated mirror with a tooth alignment template that is used with predisposed indicia representing teeth that allow markings for accurate alignment of a drill during the implant drilling operation while the periodontist holds the mirror. The shape of the mirror body aids in the alignment and manipulation.

### SUMMARY OF THE INVENTION

A mirror with indicia, which aids a periodontist in aligning a jaw bone drill so that an implant hole is properly spaced from other teeth and aligned in a patient's jaw bone, that includes a relatively flat planar mirror body having at least one side with a light reflecting mirrored surface and being fairly rigid, the mirror body being elongated and having a first longitudinal side that is substantially straight with one concave indentation approximately one third from the distal end of the mirror.

For use by a periodontist, the mirror includes in its central portion along the right longitudinal edge, lined visible printed indicia that are placed on the mirror surface with a transparent tape that contains the printed indicia. The indicia are specifically sized and shaped to resemble one or more teeth and to provide alignment shapes and lines that can be used by a periodontist as guidelines for drilling dental implant holes in a patient's jaw bone. The periodontist holds the mirror in the patient's mouth while simultaneously drilling dental implant holes properly aligned and properly spaced from other teeth by observing the indicia guide with the mirror placed in one hand and the drill in the other hand. The indicia may include three or more representatively shaped teeth in cross section with vertically-oriented guidelines disposed therethrough. The indicia lines and shapes have been predetermined in size, shape and orientation and strategically placed on the mirror surface through trial and error to work extremely well. Various indicia may be employed depending on the patient and implant to be performed.

The mirror body itself may be constructed from metal that is highly polished to allow reflection on both sides as a mirror. The mirror could also be made of heavy duty plastic that contains a coated mirrored surface. The length, width and contour of the mirror body is selected to aid in the manipulation of the mirror in the patient's mouth.

As described above, the indicia could be permanently embossed or inscribed with lines into the surface of the mirror or could be attached with translucent tape that shows the indicia lines. The indicia could be painted, lined, inscribed or applied in conventional method of putting indicia (even printing) on the surface of a plastic, metal or glass mirror.

An object of this invention is to provide a precision tool for a periodontist that can be used for drilling a properly spaced and aligned implant hole into a patient's jaw bone while using the mirror for alignment purposes.

Yet another object of this invention is to provide an improved mirror with alignment and spacing indicia for periodontists (and orthodontists) that is sized and shaped for easy manipulation and access inside the patient's mouth while providing optimum visual observation to the periodontist while drilling an implant hole in a jaw bone.

In accordance with these and other objects which will become apparent hereinafter, the instant invention will now be described with particular reference to the accompanying drawings.

### BRIEF DESCRIPTION OF THE DRAWINGS

FIG. 1 shows a top plan view of the present invention with the alignment indicia attached that include guidelines for drilling dental implant holes.

FIG. 2 shows a bottom plan view of the present invention with the alignment indicia attached that include guidelines for drilling dental implant holes.

FIG. 3 shows a top plan view of the invention that includes dimensions for understanding the size of the present invention.

FIG. 4 shows a left side elevational view of the invention.

### DETAILED DESCRIPTION

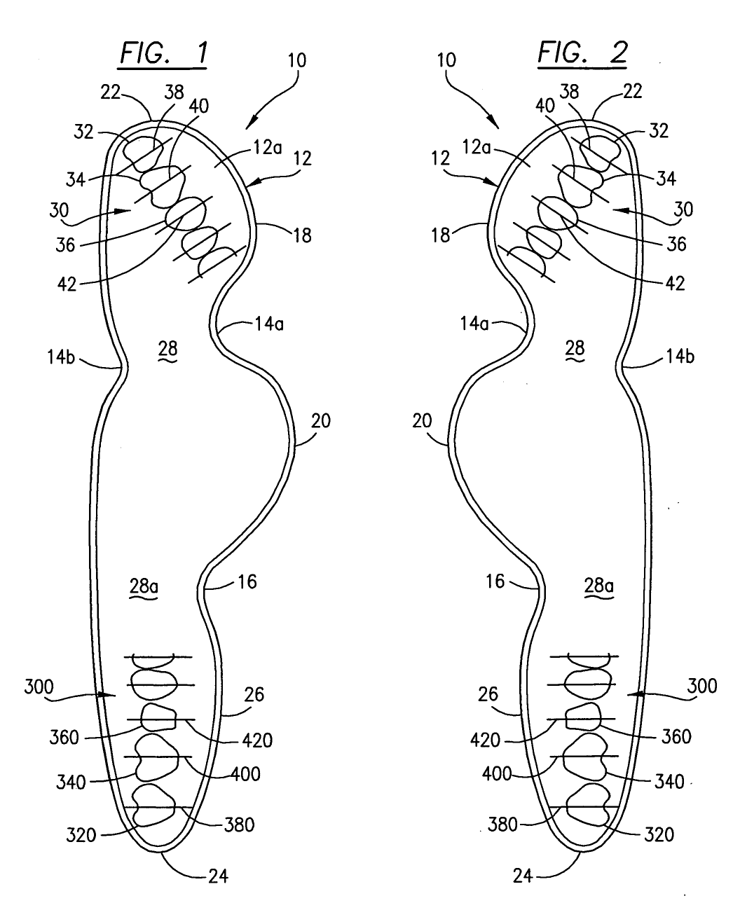

Referring now to FIG. 1, the present invention is shown generally at 10 comprised of a rigid metal mirror body 12 having a plurality of predetermined arcuate concave indentations 14 and 16 and a pair of arcuate convex protrusions 18 and 20 of predetermined size. The rigid body 12 may be made of metal with a surface 12a of highly polished texture to allow reflection as a mirror. The surface 12a could also be a mirrored added surface such as a coating that reflects light. In an alternate embodiment, the body 12 could be constructed from plastic with a mirrored coating 12a disposed on both sides. Both sides of the body 12 contain a mirrored surface 12a.

One of the longitudinal sides has only a small concave indentation 14 and is substantially linear from the distal end 22 to the proximal end 24. The distal end 22 would be the end that may be inserted into the patient's mouth first while the proximal end 24 contains a handle portion 26 that is sized for grasping by the user.

The shape of body 12 including the recessed portions 14 and 16 show a narrowed width portion 28 and 28a across from the arcuate portions.

A dental implant requires embedding a post in the jaw bone. This requires drilling a precisely aligned and spaced hole in the jaw relative to the remaining teeth. A major purpose of this invention is to facilitate alignment and spacing of the hole while drilling the hole for a dental implant in a jaw bone. The shape of the mirror 10 allows for easier manual manipulation by the periodontist while aligning and drilling. The mirror shape comfortably fits the lip and tongue areas and the cheek and gums areas. The present invention 10 can act as a tongue pusher and a cheek retractor that allows seeing numerous teeth at one time. The device also conforms to the shape and size of the lips. The mirror 10 as shown in FIG. 1 replaces the old circular lollipop mirror.

Referring now to FIGS. 1 and 2, the mirrored body 12 shows the addition of printed indicia 30 and 300 that include the representation of a first tooth 32, a second tooth 34 and third tooth 36 near distal end 22 and fourth tooth 320, fifth tooth 340 and sixth tooth 360 near proximal end 24. Each of the teeth indicia 32, 34 and 36 include straight lines 38, 40 and 42 that basically bisect the tooth surfaces 32, 34 and 36 as shown in the indicia. In addition, each of the teeth indicia 320, 340 and 360 include straight lines 380, 400 and 420 that bisect the tooth surfaces 320, 340 and 360 as shown in the indicia of the proximal end 24. Both locations and layout for the tooth surfaces shown in the indicia 30 and 300 have been shown by trial and error to allow precise alignment and spacing during the act of drilling a tooth implant jaw bone hole by a periodontist. For example, the periodontist can align the indicia guidelines 38 and 40 and 380 and 400 while the mirror is being held in the patient's mouth by the periodontist with one hand in order to drill a straight line hole for a dental implant using the indicia guidelines 38, 40, 380 or 400. The drill is operated using the other hand. The indicia 30 and 300 may be made with a translucent or transparent tape that is added at the specific locations shown for proper use. The indicia 30 and 300 could also be inscribed or could be of a raised surface that has black paint on it to illustrate the outline, such as embossing.

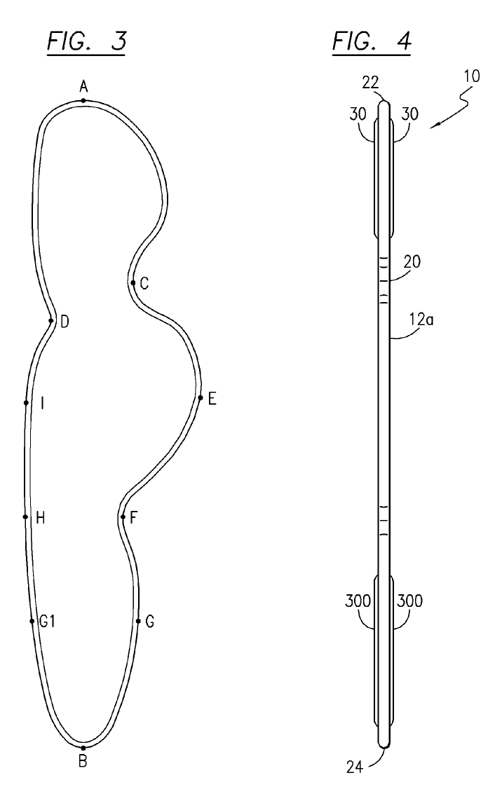

Referring now to FIG. 3, the present invention is shown with specific dimensions such that the length from A to B is 7 inches. The distance from C to D is 1 inch. The distance from E to I is 1-⅞ inches. The distance from F to H is 1-⅛ inches. The handle width from G to G1 is 1-⅛ inches.

Using the present invention, the periodontist can use the mirror 10 with the prescribed indicia 30 or 300 (either end of the mirror) to perform the drilling for a dental implant with a precisely aligned hole using guidelines provided on the mirror surface. In addition, the mirror 10 provides an unimpeded view for any dentist, orthodontist or periodontist to view one or more teeth anywhere in a patient's mouth. The shape of the mirror body is comfortable for the patient and easily manipulated by the dentist or periodontist within the patient's mouth.

The instant invention has been shown and described herein in what is considered to be the most practical and preferred embodiment. It is recognized, however, that departures may be made therefrom within the scope of the invention and that obvious modifications will occur to a person skilled in the art.

1. (canceled)

2. (canceled)

3. (canceled)

4. The method of drilling a jaw bone hole for an implant comprising the steps of:
(a) providing a mirror having indicia useful for alignment and spacing of the implant hole in the jaw bone; and
(b) using the mirror indicia while drilling the implant hole.

5. (canceled)

6. (canceled)

7. (canceled)
